(19) United States
(12) Patent Application Publication
(10) Pub. No.: US 2009/0250832 A1
(43) Pub. Date: Oct. 8, 2009

(54) METHOD FOR MANUFACTURING PATTERNED BAKING TRAY

(76) Inventor: Yu Tzu Wang, Taipei (TW)

Correspondence Address: Wang Law Firm, Inc., 4989 Peachtree Parkway,, Suite 200, Norcross, GA, 30092, US

(21) Appl. No.: 12/061,189

(22) Filed: Apr. 2, 2008

(51) Int. Cl. B29C 67/00

(52) U.S. Cl. 264/134

(57) ABSTRACT

A method for manufacturing a patterned baking tray comprises steps of: removing dirt and grease from a first surface and a second surface of an unpainted flat plate; sandblasting said surfaces; spray-coating the first surface with a first primer and baking the first primer; spray-coating the first surface which has been spray-coated with the first primer with a fluorine-containing resin and baking the fluorine-containing resin; spray-coating the second surface of the flat plate with a second primer and baking the second primer; screen-printing the pattern onto the second surface which has been spray-coated with the second primer and baking the printed pattern; and stretch-forming the flat plate into the baking tray having the printed pattern on an outer surface thereof. The method allows a baking tray having an irregular shape to be formed with a pattern thereon and thus beautifies the baking tray.

### BACKGROUND OF THE INVENTION

1. Technical Field

The present invention relates to a method for patterning a surface of a baking tray and, more particularly, to a method of printing a pattern onto a flat plate and then forming the flat plate into a baking tray having a small thickness and an irregular shape, so that the pattern is formed on a surface of the baking tray.

2. Description of Related Art

Metal cooking pots and pans decorated with patterns on outer surfaces thereof can be found on the market. These patterns are formed, for example, by bake coating or with heat transfer stickers, so as to adapt to the high-temperature environment in which the pots are pans are used. On the other hand, baking trays (boxes) for making cakes and pastries are usually not colored and available only in their original metal colors.

The baking trays are not decorated with patterns because of thicknesses thereof. A baking tray is normally made of a material having a thickness between 0.5 and 1.0 mm whereas a cooking pot or pan generally has a thickness of 2.5 mm or above. Now that the bake coating or heat transfer techniques for coloring, or transferring patterns onto, cooking pots and pans have operating temperatures higher than 600° C., which are way beyond the 280° C. thermal limit of baking trays, the already-formed baking trays will deform if those techniques are applied thereto. Another reason why the baking trays are not formed with patterns is that the baking trays have irregular contours for providing a variety of cake shapes. The variously contoured surfaces of the baking trays make it more difficult to transfer or attach patterns thereon and increase the failure rate of such operations. As a result, there are currently no baking trays coated or attached with patterns.

### BRIEF SUMMARY OF THE INVENTION

In view of the fact that the problems associated with providing a baking tray with a surface pattern have not been solved, the present invention aims to provide a method for patterning a surface of a baking tray and, more particularly, a method of using a screen printing process to form a pattern on a baking tray, so that the baking tray having an irregular shape and a smaller thickness than a thickness of a common cooking pot or pan can be decorated with the pattern and thereby beautified.

To achieve this end, the present invention provides a method for manufacturing a patterned baking tray comprising steps of: removing dirt and grease from a first surface and a second surface of an unpainted flat plate; sandblasting said surfaces of the flat plate; spray-coating the first surface, which is intended to be an inner surface of the baking tray when the baking tray is formed, with a first primer and baking the first primer at 100 to 200° C. for 5 to 10 minutes; spray-coating the first surface which has been spray-coated with the first primer with a fluorine-containing resin and baking the fluorine-containing resin at 380 to 400° C. for 10 to 15 minutes; spray-coating the second surface of the flat plate with a second primer and baking the second primer at 100 to 200° C. for 5 to 10 minutes; screen-printing the pattern onto the second surface which has been spray-coated with the second primer and baking the printed pattern at 180 to 250° C. for 10 to 15 minutes; and stretch-forming the flat plate into the baking tray.

In the foregoing steps, the fluorine-containing resin spray-coated on the first surface of the flat plate is preferably a Teflon resin (polytetrafluoroethylene; PTFE) while the second primer spray-coated on the second surface of the flat plate is preferable a polymer resin (polyurethane; PU) and more preferably a food-grade polymer resin.

Following the foregoing steps, the baking tray thus formed is provided with the pattern and a color on an outer surface thereof, regardless whether the baking tray has a regular shape or not. In addition, the pattern can be printed on the outer surface, the inner surface or both said surfaces of the baking tray.

In the foregoing method for manufacturing the patterned baking tray according to the present invention, a flat plate is formed with a decorative pattern on a surface thereof before the flat plate is stretch-formed into the baking tray. Therefore, the baking tray will not be deformed by the high temperatures of bake coating or transfer printing. Furthermore, by using the manufacturing method of the present invention, a baking tray having an irregular shape can be successfully decorated with a flat pattern. Thus, the method for manufacturing the patterned baking tray according to the present invention increases the esthetics as well as the value of the baking tray.

### BRIEF DESCRIPTION OF THE SEVERAL VIEWS OF THE DRAWINGS

The invention as well as a preferred mode of use, further objectives and advantages thereof will best be understood by reference to the following detailed description of an illustrative embodiment when read in conjunction with the accompanying drawing, wherein:

FIG. 1 is a flow chart of a method for manufacturing a baking tray having a pattern thereon according to a preferred embodiment of the present invention.

### DETAILED DESCRIPTION OF THE INVENTION

Generally, a baking tray can be formed by two approaches, namely post-coating (i.e., coating is performed after a baking tray is formed) and pre-coating (i.e., a flat plate is bake-coated before it is stretch-formed into a baking tray). A screen-printed baking tray manufactured by the method of the present invention is formed by the pre-coating approach.

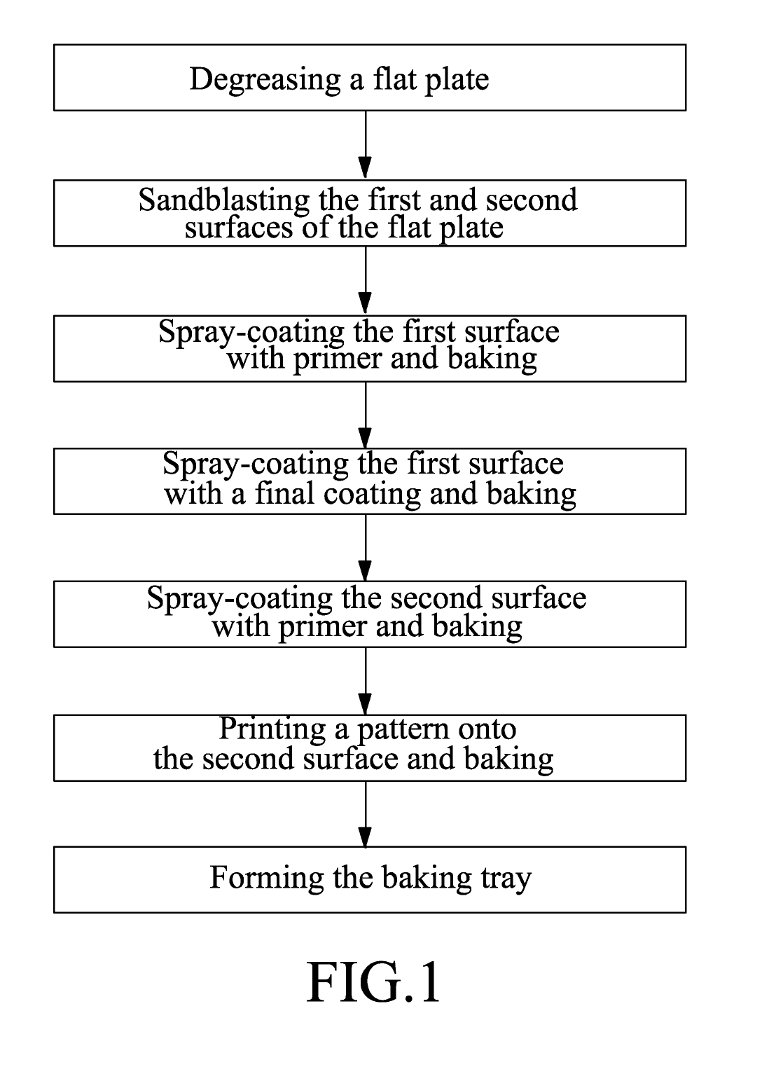

Refer to FIG. 1 for the flow chart of the method for manufacturing a patterned baking tray according to the preferred embodiment of the present invention, wherein the method comprises the following steps:

Degreasing a Flat Plate

A flat plate having a first surface and a second surface, both unpainted, is cleaned with an alkaline cleanser to remove dirt and grease from said surfaces.

Sandblasting the First and Second Surfaces of the Flat Plate

Both the first and second surfaces of the degreased flat plate are sandblasted to facilitate attachment of primers in subsequent steps.

Spray-Coating the First Surface with Primer and Baking

The first surface of the flat plate, which is intended to be an inner surface of the baking tray when the baking tray is formed, is spray-coated with a first primer, and the first primer is baked at 100 to 200° C. (preferably 150° C.) for 5 to 10 minutes.

Spray-Coating the First Surface with a Final Coating and Baking

The first surface of the flat plate which has been spray-coated with the first primer is further spray-coated with a fluorine-containing resin, and the fluorine-containing resin is baked at 380 to 400° C. for 10 to 15 minutes.

Spray-Coating the Second Surface with Primer and Baking

The second surface of the flat plate is spray-coated with a second primer, and the second primer is baked at 100 to 200° C. (preferably 150° C.) for 5 to 10 minutes.

Printing a Pattern onto the Second Surface and Baking

The second surface which has been spray-coated with the second primer is screen-printed with a pattern, and the printed pattern is baked at 180 to 250° C. (preferably 220° C.) for 10 to 15 minutes (preferably 12 minutes).

Forming the Baking Tray

The flat plate that has gone through the previous steps is stretch-formed into the baking tray, wherein the baking tray has the printed pattern on an outer surface thereof.

In the foregoing steps, the fluorine-containing resin spray-coated on the first surface of the flat plate is preferably a Teflon resin (polytetrafluoroethylene; PTFE).

In the foregoing steps, the second primer spray-coated on the second surface of the flat plate is preferable a polymer resin (polyurethane; PU) and more preferably a food-grade polymer resin.

Following the foregoing steps, the baking tray thus formed is provided with the pattern and a color on the outer surface thereof, regardless whether the baking tray has a regular shape or not.

In the preferred embodiment of the present invention described above, the pattern is printed only on the outer surface of the baking tray. However, the same steps can also be applied to print a pattern on the inner surface of the baking tray, as long as the safety of food supported thereon is not disadvantageously affected.

The present invention has been described with the preferred embodiment thereof and it is understood that the embodiment is not intended to limit the scope of the present invention. Moreover, as the content disclosed herein should be readily understood and can be implemented by a person skilled in the art, all equivalent changes or modifications which do not depart from the spirit of the present invention are encompassed by the appended claims.

1. A method for manufacturing a patterned baking tray, comprising steps of:
removing dirt and grease from a first surface and a second surface of an unpainted flat plate;
sandblasting said surfaces of the flat plate;
spray-coating the first surface, which is intended to be an inner surface of the baking tray when the baking tray is formed, with a first primer, and baking the first primer at 100 to 200° C. for 5 to 10 minutes;
spray-coating the first surface which has been spray-coated with the first primer with a fluorine-containing resin, and baking the fluorine-containing resin at 380 to 400° C. for 10 to 15 minutes;
spray-coating the second surface of the flat plate with a second primer, and baking the second primer at 100 to 200° C. for 5 to 10 minutes;
screen-printing the pattern onto the second surface which has been spray-coated with the second primer, and baking the printed pattern at 180 to 250° C. for 10 to 15 minutes; and
stretch-forming the flat plate into the baking tray, which has the printed pattern on an outer surface thereof.

2. The method for manufacturing the patterned baking tray as claimed in claim 1, wherein the fluorine-containing resin spray-coated on the first surface of the flat plate is polytetrafluoroethylene (PTFE).

3. The method for manufacturing the patterned baking tray as claimed in claim 1, wherein the second primer spray-coated on the second surface of the flat plate is a polymer resin (polyurethane; PU).

4. The method for manufacturing the patterned baking tray as claimed in claim 1, wherein the second primer spray-coated on the second surface of the flat plate is a food-grade polymer resin.

5. The method for manufacturing the patterned baking tray as claimed in claim 1, further comprising a step of printing a pattern on the first surface of the flat plate.

6. The method for manufacturing the patterned baking tray as claimed in claim 1, wherein the first primer on the first surface of the flat plate is baked at 150° C.

7. The method for manufacturing the patterned baking tray as claimed in claim 1, wherein the second primer on the second surface of the flat plate is baked at 150° C.

8. The method for manufacturing the patterned baking tray as claimed in claim 1, wherein the printed pattern on the second surface of the flat plate is baked at 220° C. for 12 minutes.
